(19) United States
(12) Patent Application Publication
(10) Pub. No.: US 2014/0252810 A1
(43) Pub. Date: Sep. 11, 2014

(54) SEAT ASSISTANT SIDE CUSHION TRAY

(71) Applicant: HONDA MOTOR CO., LTD., (US)

(72) Inventor: Kelly Michael Whalen, Worthington, OH (US)

(73) Assignee: HONDA MOTOR CO., LTD., Tokyo (JP)

(21) Appl. No.: 13/791,154

(22) Filed: Mar. 8, 2013

(51) Int. Cl. B60N 3/00

(52) U.S. Cl. CPC B60N 3/002
USPC 297/135

(57) ABSTRACT

A tray assembly for an associated automotive vehicle includes a tray dimensioned for receipt on a seat portion. Individual compartments along an upper surface are provide to store associated items therein. A leveling mechanism compensates for a slope in the cushion portion of the seat so that the tray compartments are substantially level. A restraint, front bag holder, or pocket is integrally hinged to the tray for movement through approximately 270 degrees from (i) a storage position overlying the tray and a (ii) deployed position selectively extending from adjacent the front edge of the seat portion toward a floor and includes an opening that receives associated items.

### BACKGROUND

This disclosure is directed to a tray, and particularly a tray for use in an automotive vehicle. The disclosure finds particular application in a vehicle, for example, where first and second seats are disposed in a spaced, side-by-side orientation and there is insufficient center tray space between the seats. However, the disclosure may find application in related environments and uses that are faced with similar difficulties and constraints.

It is common to provide storage areas and cupholders in automotive vehicles. For example, multiple cupholders are desired by vehicle occupants. A common location to incorporate the cupholders is on a center tray or console disposed between the front seats. Unfortunately, the remaining tray space is insufficient for all of the items that many drivers today require to be close by. For example, tray space is required for food, mobile phones, portable navigation systems, music devices, pens, tickets, coins, purse, briefcase, books, newspaper, etc.

In other instances, some vehicles include a center console that has a large armrest. The large armrest is incapable of holding items on its top surface. As a result, many vehicle users store items on the cushion surface of the adjacent seat. However, the seat cushion or seat portion of the adjacent seat is typically sloped and/or presents a large, wide open area. Items can slide off the seat to the floor or slide across the seat cushion and, as a result, the items can slide out of convenient reach for the driver, or may even slide off of the seat portion of the adjacent front seat. As a result, the items occasionally slide off the seat cushion of the adjacent seat and become lost between the door lining and the seat.

Still further, when the driver uses the adjacent front seat as a storage surface, the seat fabric is exposed to food items. Since the items are not secured from sliding, this raises the potential that food can spill onto the seat fabric and result in staining.

In other instances, vehicle occupants use the cushion to store a purse, briefcase, or bag on an adjacent seat. During braking, because the purse, briefcase, or bag is not restrained, the contents are potentially compromised and can shift or fall forward to the floor/foot well of the vehicle.

In some instances, it is desirable that the tray assembly be self-contained and removable from the seat and/or removable from the vehicle when needed.

Consequently, a need exists for an improved tray assembly that provides additional and organized tray space for items that now are commonly stored in vehicles. It is also desired that the tray can be neatly stored out of the way when not in use so that the adjacent front seat can be used by a passenger. Preferably, storage of the tray is easily accomplished and presents an aesthetically desirable look to the vehicle interior and likewise during use the tray provides for an organized arrangement of items of different size.

### SUMMARY

A seat tray assembly for an automotive vehicle seat that includes a seat portion and a seat back is provided. The seat tray assembly includes a tray dimensioned for receipt on a seat portion, and a restraint, front bag holder, or pocket along a front edge of the tray extending in front of and below the seat portion.

Preferably the restraint, front bag holder, or pocket is hinged to the front edge of the tray.

The tray has a general wedge shape in one embodiment that increases in depth from the front edge toward a rear edge adjacent the seat back.

The tray includes multiple storage compartments segregated from one another for receiving associated items therein, and preferably items of different sizes.

The tray is secured to the seat with at least one strap.

In another arrangement, the tray is stored in a surface of the seat back.

Tray is configured for folding outwardly approximately ninety degrees (90°) from the seat back for receipt on the seat portion.

The pocket is configured for folding outwardly approximately 270° from the seat portion for receipt in front of and below the seat portion.

A wedge-shaped portion may be received between the upper surface of the tray and the seat portion and that has a slope generally similar to a slope of the seat portion.

One or more of the storage compartments may include a removable bin.

A primary benefit is the provision of a tray assembly that increases the amount of free space to accommodate an increased number of items stored in a vehicle.

Another advantage resides in the ability to support the items in a manner that the items do not slide off the seat.

Yet another benefit is the ability to conveniently stow the tray portion in an aesthetically pleasing manner when not in use, and likewise provides for organized storage of items when in use.

Still other benefits and advantages may be found upon reading and understanding the following detailed description

### BRIEF DESCRIPTION OF THE DRAWINGS

FIG. 1 is a schematic perspective illustration of a tray assembly situated on a seat, such as a passenger or assistant seat adjacent the driver.

FIG. 2 schematically illustrates the tray assembly of FIG. 1 in a deployed arrangement.

FIG. 3 schematically illustrates the tray assembly of FIGS. 1 and 2 with a front pocket pivoted open.

FIG. 4 is a side of the tray assembly of FIGS. 1-3 in a deployed position.

FIG. 5 is a schematic perspective view of another embodiment of a tray assembly that is integrated into the seat.

FIG. 6 is a side view of a tray assembly that includes optional removable bins.

### DETAILED DESCRIPTION

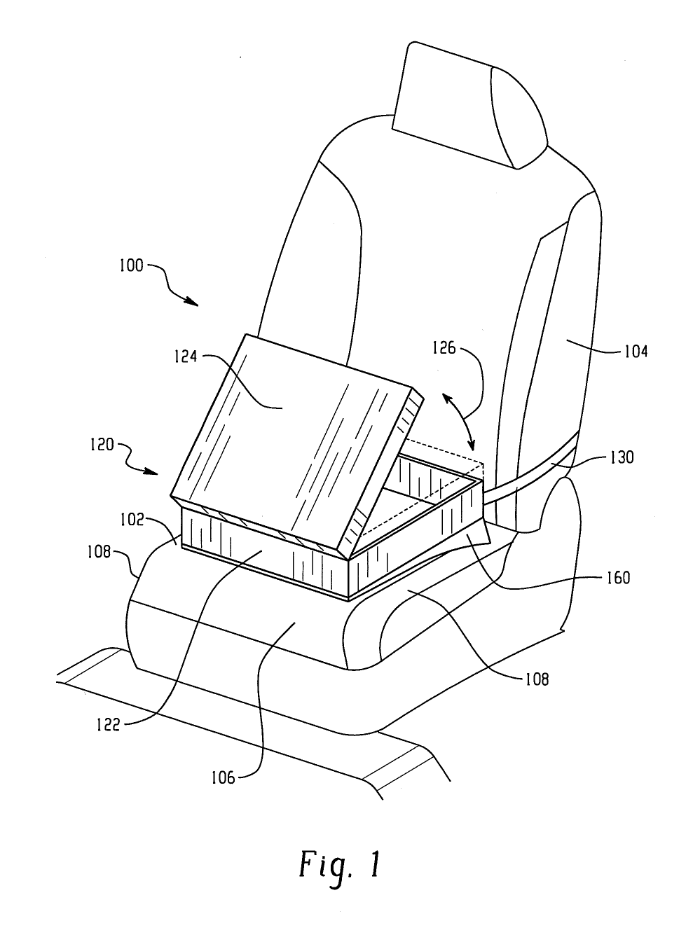

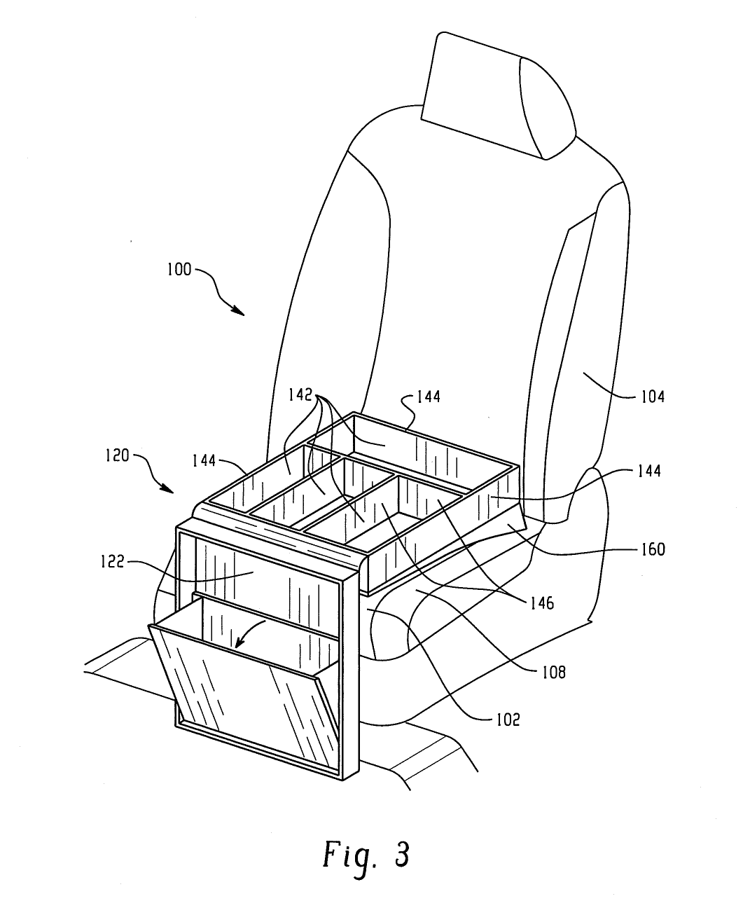

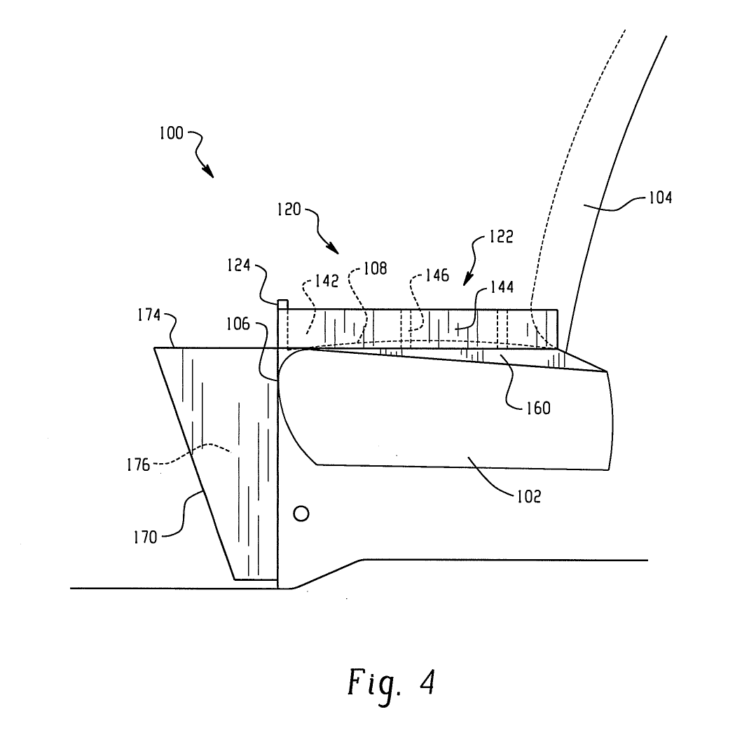

Turning initially to FIGS. 1-4, there is shown a seat 100 such as an assistant seat (where the driver seat is not shown) and the assistant seat and driver seat are disposed in a spaced apart, side-by-side configuration. The seat 100 includes a seat portion 102 and a seat back 104. Typically, the seat portion 102 is not truly horizontal and has a slope or incline from a front edge 106 toward the seat back 104. In addition, side edges or bolsters 108 are slightly raised relative to the remainder of the seat portion 102.

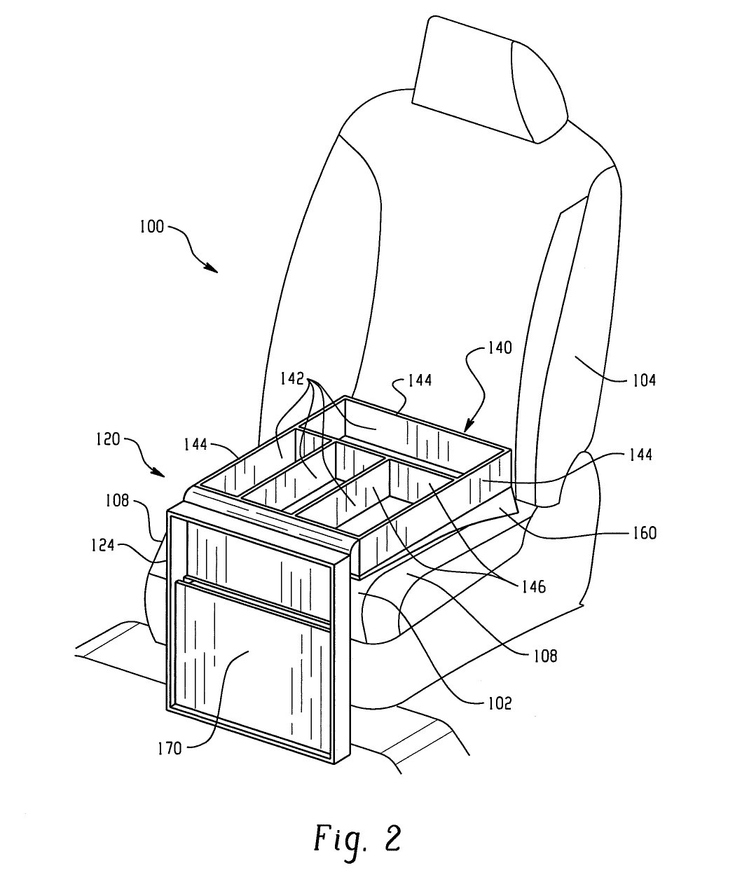

A seat tray assembly 120 is provided. The tray assembly 120 includes a tray 122 dimensioned and configured for receipt on the seat portion 102. More particularly, the tray 122 is preferably dimensioned for receipt in a lateral direction between the seat bolsters 108, and extends from the seat back 104 toward the front edge 106. The tray assembly 120 may be a self-contained unit that includes a lid 124 that covers an upper surface of the tray 122 (FIG. 1) in a first or storage position. Likewise, the lid 124 is preferably hinged to a front edge of the tray and pivots or rotates as represented by reference arrow 126 through approximately two hundred seventy degrees (270°) to a use or deployed position (FIGS. 2-4). The tray assembly is preferably secured to the seat in this embodiment with straps 130 or similar restraining members

The tray 122 includes a first or upper surface 140 that includes two or more compartments 142 defined by sidewalls 144 and dividing walls 146. Although the perimeter shape of the tray assembly 120 has a generally rectangular conformation, this does not preclude different shapes, configurations, or sizes. Likewise, the compartments 142 are shown as being different sizes and the variation is also contemplated relative to the size, depth, and the shape of the different compartments. Preferably the compartments 142 are easily accessible when the lid 124 is in the deployed position. By way of example only, some of the smaller, or more shallow compartments 142 can easily accommodate pens, pencils, gum, mints, tickets, coins (not shown), etc. The intermediate sized compartments 142 may hold mobile phones, MP3 players, portable navigation systems (not shown), etc. Still further, the deeper or larger compartments 142 are dimensioned to receive a purse, book, newspapers (not shown), etc. In the illustrated embodiment, each of the compartments 142 is open-topped, although this need not necessarily be the case.

A leveling mechanism 160 may also be provided. The leveling mechanism 160 may be a wedge-shaped bottom portion (integrated into the tray or a separate member) that has the same general conformation or angle as the sloping seat portion 102. Thus, in one embodiment, the compartments 142 of the tray 122 have the same general depth. In another arrangement, the depth of the compartments 142 may vary as the bottom surface of the tray 122 has a slope that increases from the front edge toward the seat back 104, i.e., those compartments 142 located adjacent the seat back have a greater depth. The lid 124 is preferably integrally joined to the tray 122.

In addition, the lid forms a restraint, front bag holder, or pocket 170. In one arrangement, the pocket 170 is pivoted outwardly as represented by reference arrow 172 to form a receiving opening 174 allowing access to an interior cavity 176 that is dimensioned to receive larger items such as a briefcase, large purse, laptop computer, (not shown) etc. If no item is stored or received in the pocket 170, the pocket will adopt a flush configuration with the remainder of the lid 124 (FIG. 2).

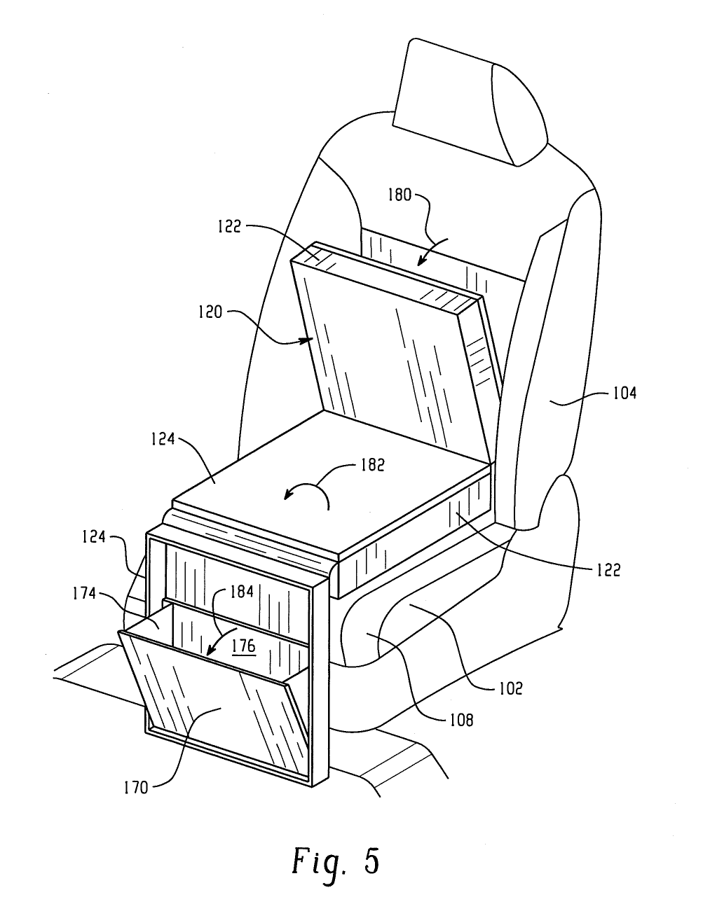

FIG. 5 shows a slightly modified embodiment, where like reference numerals refer to like components for brevity and ease of understanding. In this arrangement, the tray assembly 120 is incorporated into the seat back 104. Thus, that portion of the tray assembly 120 that rests on the seat portion 102 when the tray assembly is in use, forms a lower portion of the seat back 104 when the tray assembly is stowed therein. This provides for an aesthetically pleasing stored arrangement of the tray assembly 120, which may be contrasted with the tray assembly of FIGS. 1-4 where the tray assembly 120 is removed from the seat by unfastening the strap 130, and the tray assembly may be stored elsewhere in the vehicle or even removed from the vehicle. In the arrangement of FIG. 5, however, the tray assembly 120 is folded into the seat back 104. Thus, to deploy the tray assembly 120 from its stowed position, the tray assembly is pivoted or rotated downwardly through approximately 90° as represented by reference numeral 180 so that the tray assembly rests on the seat portion 102. Subsequently, the lid 124 is further rotated through approximately 270° as represented by reference numeral 182 to a deployed position where the pocket 170 may be accessed at a location in front of the seat, and generally below a plane defined by the seat portion 102 (and likewise in front of and below the tray 122 when the tray is in the use position).

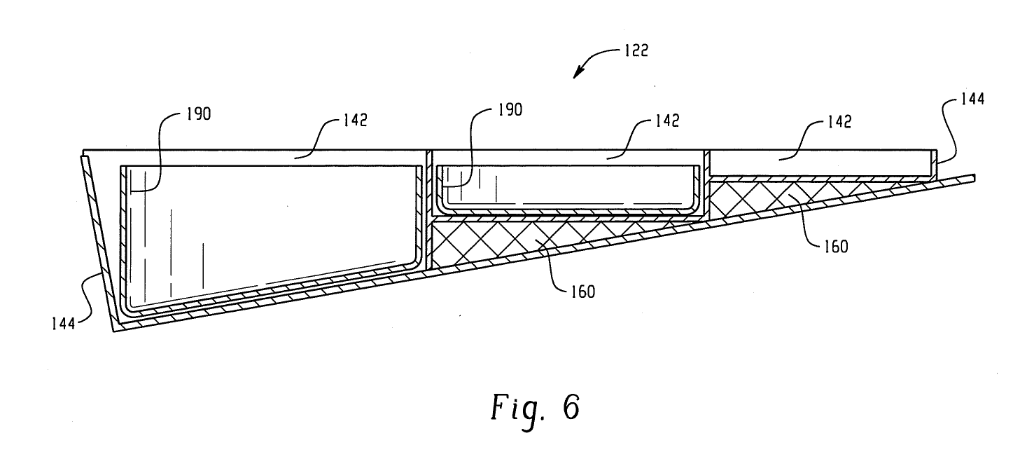

FIG. 6 illustrates the inclusion of separate removable bins 190 dimensioned for receipt in the individual compartments 142. The bins 190 may have different shapes or depths.

The tray assembly 120 is situated on the seat cushion surface 102 and may be secured to the seat by straps 130. The tray assembly 120 is self-contained removable when needed. The tray assembly 120 includes a hinged lid 124, shallow, divided tray 122, all constructed on a platform that provides a level surface for objects to be stored. The tray assembly 120 also includes a restraint or pocket 170 disposed in front of and below the cushion to hold a purse, bag, briefcase, etc.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A seat tray assembly for an automotive vehicle seat that includes a seat portion and a seat back, the seat tray assembly comprising:
a tray dimensioned for receipt on a seat portion; and
a restraint along a front edge of the tray, the restraint extending in front of and below the seat portion.

2. The seat tray assembly of claim 1 wherein the restraint is a pocket is hinged to the front edge of the tray.

3. The seat tray assembly of claim 1 wherein the tray has a general wedge shape that increases in depth from the front edge toward a rear edge adjacent the seat back.

4. The seat tray assembly of claim 1 wherein the tray includes multiple storage compartments segmented from one another for receiving associated items therein.

5. The seat tray assembly of claim 1 wherein the tray is secured to the seat with at least one strap.

6. The seat tray assembly of claim 1 wherein the tray is stored in a surface of the seat back.

7. The seat tray assembly of claim 6 wherein the tray is configured for folding outwardly approximately ninety degrees from the seat back for receipt on the seat portion.

8. The seat tray assembly of claim 7 wherein the restraint is a pocket configured for folding outwardly approximately 270 degrees from the seat portion for receipt in front of and below the seat portion.

9. The seat tray assembly of claim 1 wherein the tray includes at least one wedge-shaped portion received between an upper surface of the tray and the seat portion that has a slope generally similar to a slope of the seat portion.

10. The seat tray assembly of claim 9 wherein the wedge-shaped portion is disposed between a lower surface of the tray and the seat portion.

11. The seat tray assembly of claim 9 wherein the tray includes multiple storage compartments segmented from one another for receiving associated items therein, and at least first and second storage compartments each include a removable bin.

12. A seat tray assembly for an automotive vehicle comprising:
a tray configured for receipt on a seat portion of a seat, the tray having an upper, first surface divided into separate compartments;
a leveling mechanism operatively associated with the tray that compensates for a slope in the seat portion of the seat so that the tray compartments are substantially level from adjacent a seat back to a front edge of the seat portion; and
a front bag holder that extends from adjacent the front edge of the seat portion toward a floor and including an opening that receives associated items into the front bag holder.

13. The seat tray assembly of claim 12 wherein the tray is integrally hinged to the front bag holder.

14. The seat tray assembly of claim 12 wherein the leveling mechanism is disposed along a lower surface of the tray and the compartments each have substantially the same depth.

15. The seat tray assembly of claim 12 wherein the leveling mechanism includes a sloping lower surface and the compartments have increasing depths from adjacent a seat back toward the front edge of the seat portion.

16. The seat tray assembly of claim 12 wherein the tray forms a part of a seat back and is pivoted through approximately 90 degrees for support on the seat portion.

17. The seat tray assembly of claim 12 further comprising removable bins received in the compartments.

18. A seat tray assembly for an automotive vehicle having a seat that includes a seat back and a seat portion, the seat tray assembly comprising:
a tray dimensioned and configured for receipt on the seat portion, and having individual compartments along an upper surface thereof for storing associated items therein;
a leveling mechanism operatively associated with the tray that compensates for a slope in the seat portion of the seat so that the tray compartments are substantially level from adjacent the seat back to a front edge of the seat portion; and
a front bag holder integrally hinged to the tray for movement through approximately 270 degrees from (i) a storage position overlying the tray and a (ii) deployed position selectively extending from adjacent the front edge of the seat portion toward a floor and including an opening that receives associated items into the front bag holder.

19. The seat tray assembly of claim 18 wherein the tray and front bag holder form a part of a seat back and are pivoted through approximately 90 degrees to the storage position where the tray and front bag holder are support on the seat portion.

20. The seat tray assembly of claim 18 wherein the leveling mechanism is either disposed along a lower surface of the tray and the compartments each have substantially the same depth, or includes a sloping lower surface and the compartments have increasing depths from adjacent a seat back toward the front edge of the seat portion.
